(19) United States
(12) Patent Application Publication
(10) Pub. No.: US 2024/0352877 A1
(43) Pub. Date: Oct. 24, 2024

(54) APPLICATOR TOOL POSITIONABLE WITHIN A VALVE SEAT BORE OF A CYLINDER HEAD FOR AN INTERNAL COMBUSTION ENGINE

(71) Applicant: INNIO Jenbacher GmbH & Co OG, Jenbach (AT)

(72) Inventor: Sandro Rivellini, Innsbruck (AT)

(21) Appl. No.: 18/641,303

(22) Filed: Apr. 19, 2024

(30) Foreign Application Priority Data
Apr. 20, 2023 (EP) 23168988.6

(51) Int. Cl. F01L 3/22

(52) U.S. Cl. CPC F01L 3/22

(57) ABSTRACT

An applicator tool positionable within a valve seat bore of a cylinder head for an internal combustion engine. The applicator tool includes a sealing portion extending radially outwardly from a base body of the applicator tool for sealing abutment with the valve seat bore, a wiper portion extending radially outwardly from the base body and narrower in diameter than the sealing portion, and a circumferential groove between the sealing portion and the wiper portion and recessed relative to the wiper portion, wherein the circumferential groove has a groove base which is circumferentially continuous.

### CROSS-REFERENCE TO RELATED APPLICATION

This application claims priority to and benefit of EP Application No. EP23168988.6, filed on Apr. 20, 2023, entitled “APPLICATOR TOOL POSITIONABLE WITHIN A VALVE SEAT BORE OF A CYLINDER HEAD FOR AN INTERNAL COMBUSTION ENGINE”, which is herein incorporated by reference in its entirety.

### BACKGROUND

The present invention relates to an applicator tool positionable within a valve seat bore of a cylinder head for an internal combustion engine, an arrangement of such an applicator tool and a cylinder head and/or an internal combustion engine, a method for applying a sealant to a valve seat bore of a cylinder head for an internal combustion engine, and a method for inserting a valve seat ring into a cylinder head of an internal combustion engine.

The valve seat in an internal combustion engine is the surface against which an intake or an exhaust valve rests during the portion of the engine operating cycle when that valve is closed. The valve seat maintains the airtightness of the combustion chamber to provide a favorable compression ratio and thereby efficient engine performance.

It is known by the state of the art to provide separate components-valve seat rings-comprising the valve seat, which components are installed at the cylinder head of the internal combustion engine. By use of such valve seat rings, the exact manufacturing tolerances of the valve seat do not affect the whole cylinder head, and cooling channels for the valve seat can be manufactured in a better way.

The valve seat ring is positioned within a machined valve seat bore.

Sealant is applied to the valve seat bore prior to installation of the valve seat ring within the valve seat bore therein. The sealant must be applied only to certain areas requiring coverage. The sealant must be applied evenly, and any excess sealant must be removed.

Sealants used are typically semi-fluid, because they can be applied to the necessary surfaces without runoff. Semi-fluid sealants are typically applied from a syringe-type device and/or by a brush.

A conventional method for applying sealant to the desired surfaces is to apply one or more beads of the sealant to the desired surface directly using the syringe and/or a brush.

The bead is then evenly distributed and smoothed by a person using their finger or another spreading device functioning in a similar manner.

This method has a number of shortcomings. Direct application of sealant to the surface is inconsistent and often results in unnecessary amounts of sealant being used.

Any excess sealant is removed and discarded, thereby resulting in wasted material.

Spreading the sealant manually using a person's finger or a brush is also inconsistent and the spreading of the sealant results in sealant being pushed onto surfaces where no sealant is desired.

That runover sealant must then be removed, thereby prolonging the step of applying sealant to the valve seat bore resulting in wasted time.

Moreover, the machined surfaces of the valve seat bore may have sharp edges, which can cause injury to a person's finger as it is moved over the surface.

### BRIEF DESCRIPTION

An aspect of the present invention is therefore to provide a means and a method of applying sealant to a valve seat bore, which applies sealant evenly and/or consistently to the desired surfaces and/or which avoids excessive application of sealant and/or hence also avoids wasted time or materials.

This aspect is achieved according to embodiments of the present invention by an applicator tool positionable within a valve seat bore of a cylinder head for an internal combustion engine, an arrangement of such an applicator tool and a cylinder head and/or an internal combustion engine, a method for applying a sealant to a valve seat bore of a cylinder head for an internal combustion engine, and a method for inserting a valve seat ring into a cylinder head of an internal combustion engine.

According to embodiments of the invention, an applicator tool positionable within a valve seat bore of a cylinder head for an internal combustion engine is provided, wherein the applicator tool comprises
a sealing portion extending radially outwardly from a base body of the applicator tool for sealing abutment with the valve seat bore,
a wiper portion extending radially outwardly from the base body and narrower in diameter than the sealing portion, and
a circumferential groove between the sealing portion and the wiper portion and recessed relative to the wiper portion, preferably wherein the circumferential groove has a groove base which is circumferentially continuous.

By use of an applicator tool according to embodiments of the invention, an operator can
place in a first step a sealant into the circumferential groove of the applicator tool,
insert, in a second step, the applicator tool with the positioned sealant into a valve seat bore of the cylinder head until the sealant cooperates with a wall of the valve seat bore, wherein the sealant is applied to the wall of the valve seat bore, and
remove, in a third step, the applicator tool from the valve seat bore, wherein, by the wiper portion and/or further wiper portion, an unnecessary amount of sealant is removed.

As can be seen, an applicator tool according to embodiments of the invention makes an exact positioning of sealant at defined surfaces of the valve seat bore possible, without touching the cylinder head or the internal combustion engine, wherein not only positioning accuracy and/or reproducibility, also the safety of the operator (not getting in touch with sharp edges) can be improved.

Furthermore, by use of an applicator tool according to embodiments of the invention, the sealant can be placed in a desired region, and spread an amount, wherein in an economic way sealant can be saved.

Also, the time amount for placing the sealant in the valve seat bore can be reduced, wherein the process can be improved in an economic way.

An applicator tool according to the embodiments of invention can be used at already present systems, cylinder heads and internal combustion engines.

The embodiments of the invention can preferably be used in conjunction with a reciprocating piston engine, in particular driving a generator for creating electrical energy. Combinations of internal combustion engines driving a generator are known as gensets.

In the following discussion, for example, the groove base of the circumferential groove or the further circumferential groove being circumferentially continuous can be understood to mean that the groove base is provided essentially flat and/or uninterruptedly (e.g., free of undulations or bores etc.).

Advantageous embodiments are defined in the dependent claims.

In one embodiment, the applicator tool can be provided with
a further sealing portion extending axially away from the wiper portion having a reduced-diameter end portion opposite the wiper portion for sealing cooperation with a reduced-diameter wall of the valve seat bore,
a further wiper portion extending radially outwardly from the base body and narrower in diameter than the further sealing portion, and
a further circumferential groove between the further sealing portion and the further wiper portion, wherein the further circumferential groove has a groove base which is circumferentially continuous.

It can be provided that the circumferential groove and/or the further circumferential groove viewed in the groove cross-section comprises a continuous cross-section geometry along its whole extension, preferably around the whole applicator tool.

It can be provided that the circumferential groove and/or the further circumferential groove has a groove cross-section which has at least two groove flanks and a groove base, wherein the at least two groove flanks, viewed in the groove cross-section, each transition into the groove base.

All of or singly, the groove flanks can be circumferentially continuous.

It can be provided that the groove base comprises at least partially a linear section.

It can be provided that a seat, preferably in the form of an end face, extends radially inwardly from the wiper portion or the further wiper portion for sealing cooperation with the valve seat bore or which serves as stop.

It can be provided that a sealant-receiving cavity extending circumferentially about the circumferential groove is defined between the sealing portion, wiping portion and a wall of the valve seat bore when the applicator tool is positioned within the valve seat bore.

It can be provided that a sealant-receiving cavity extends circumferentially about the further circumferential groove which is defined between the further sealing portion, the further wiping portion and a wall of the valve seat bore when the applicator tool is positioned within the valve seat bore.

It can be provided that at least one handle portion is provided extending from the sealing portion, preferably to a side facing away from the circumferential groove.

It can be provided that the applicator tool is essentially rotationally symmetric having a base axis.

It can be provided that a guiding opening is provided entering the applicator tool at the seat, preferably permeating the whole applicator tool along the base axis.

It can be provided that the guiding opening, preferably guiding bore, is configured to receive a guiding pin, wherein the application tool is guided by the guiding opening along the guiding pin.

The guiding pin can be connected or fixed at the cylinder head, preferably in or at the valve seat bore, wherein the guiding pin is arranged along the central axis of the valve seat bore.

The guiding pin can, e.g., be a guiding pin which is also used for positioning or centering a valve seat ring at or in the valve seat bore.

It can be provided that the applicator tool is formed in one piece, preferably comprising and/or consisting of and/or manufactured using a plastic material.

Furthermore, protection is sought for an arrangement comprising a cylinder head for an internal combustion engine comprising an applicator tool according to at least one of the preceding claims.

It can be provided that the applicator tool generally corresponds to the valve seat bore, preferably geometrically corresponds to the valve seat bore. Such a correspondence has not to be understood as exact correspondence, but such that a defined thickness of sealant is left behind when extracting the applicator from the valve seat bore.

It can be provided that the arrangement comprises furthermore an internal combustion engine on which the cylinder head is mounted.

Protection is also sought for a method for applying a sealant to a valve seat bore of a cylinder head for an internal combustion engine, wherein the method comprises the following steps
placing, in a first step, a sealant into the circumferential groove and/or into the further circumferential groove of an applicator tool, preferably an applicator tool according to embodiments of the invention,
inserting, in a second step, the applicator tool with the positioned sealant into a valve seat bore of the cylinder head until the sealant cooperates with a wall of the valve seat bore, preferably so that a seat of the applicator tool is contacting a corresponding cross section reduction of the valve seat bore, wherein the sealant is applied to the wall of the valve seat bore, and
removing, in a third step, the applicator tool from the valve seat bore, wherein, by the wiper portion and/or further wiper portion, an unnecessary amount of sealant is removed.

In addition, or alternatively, protection is sought for a method for inserting a valve seat ring into a cylinder head of an internal combustion engine, the method comprising the steps
placing, in a first step, a sealant into the circumferential groove and/or into the further circumferential groove of an applicator tool, preferably an applicator tool according to embodiments of the invention,
inserting, in a second step, the applicator tool with the positioned sealant into a valve seat bore of the cylinder head until the sealant cooperates with a wall of the valve seat bore, preferably so that a seat of the applicator tool is contacting a corresponding cross section reduction of the valve seat bore, wherein the sealant is applied to the wall of the valve seat bore,
removing, in a third step, the applicator tool from the valve seat bore, wherein, by the wiper portion and/or further wiper portion, an unnecessary amount of sealant is removed, and
inserting, in a fourth step, the valve seat ring into the valve seat bore, wherein a cavity between the valve seat ring and the valve seat bore is sealed by the sealant, and preferably connecting the valve seat ring to the cylinder head via the valve seat bore by hardening of the sealant.

It can be provided that the applicator tool is guided by a guiding opening of the applicator tool and a corresponding guiding pin at least during the first and third step.

It can be provided that all or at least one of the defined steps of the preceding methods are executed by an operator.

### BRIEF DESCRIPTION OF THE DRAWINGS

Further details and advantages of the invention are apparent from the accompanying figures and the following description of the drawings. The figures show:

FIG. 1 illustrates an embodiment of an arrangement of a cylinder head and a valve seat ring,

FIG. 2 illustrates a first embodiment of an applicator tool according to certain aspects of the invention,

FIG. 3 illustrates a section through the base axis of the first embodiment of FIG. 2,

FIG. 4 illustrates a perspective view of the first embodiment of FIG. 2 or 3,

FIG. 5 illustrates the detail indicated in FIG. 2, and

FIG. 6 illustrates the usage of the applicator tool.

### DETAILED DESCRIPTION

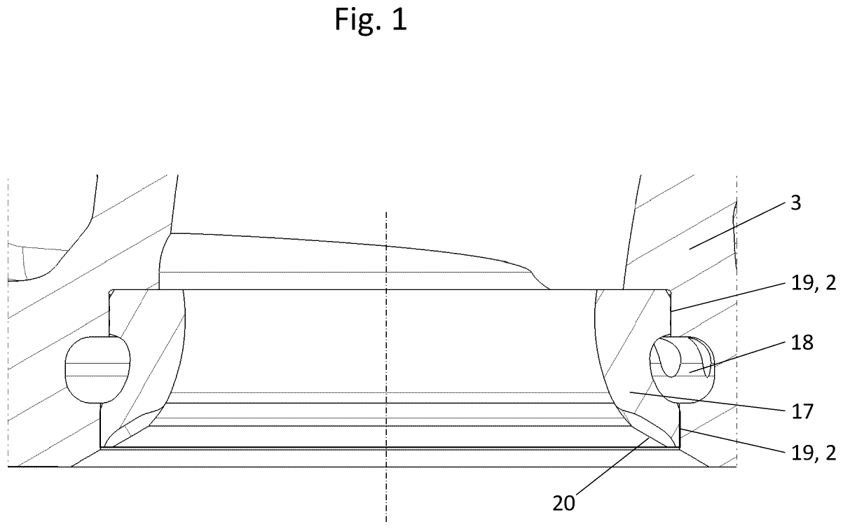

FIG. 1 discloses an embodiment of an arrangement of a cylinder head 3 and a valve seat ring 17, as known by the state of the art.

The valve seat ring 17 is positioned into a corresponding valve seat bore 2 of the cylinder head 3, wherein the valve seat 20 is provided by the valve seat ring 17.

The valve seat 20 in an internal combustion engine is the surface against which an intake or an exhaust valve rests during the portion of the engine operating cycle when that valve is closed.

The valve seat 20 maintains the airtightness of the combustion chamber to provide a favorable compression ratio and thereby efficient engine performance.

As the valve seat 20 is affected to high thermal loads and has to be manufactured with exact manufacturing tolerances, it is known to provide a separate component—the valve seat ring 17—which is installed in the cylinder head 3.

To install and fix the valve seat ring 17 in or at the valve seat bore 2 of the cylinder head 3, it is known to provide the valve seat ring 17 with a press fitting with regard to the valve seat bore 2. To introduce the valve seat ring 17 into the valve seat bore 2, in most cases the valve seat ring 17 is cooled and/or the cylinder head 3 is heated, wherein the valve seat ring 17 becomes insertable into the valve seat bore 2 (by use of thermal length extension).

Between the valve seat ring 17 and the valve seat bore 2, a cooling cavity 18 is formed, wherein during operation a cooling medium (preferably cooling water) is guided in the cooling cavity 18 for heat dissipation from the valve seat ring 17.

To seal the cooling cavity 18 and prevent leakage of the cooling medium, it is necessary to provide the contact surfaces (the walls 19 of the valve seat bore 2) of the valve seat bore 2 and the valve seat ring 17 during or before connecting these components with a sealant 16.

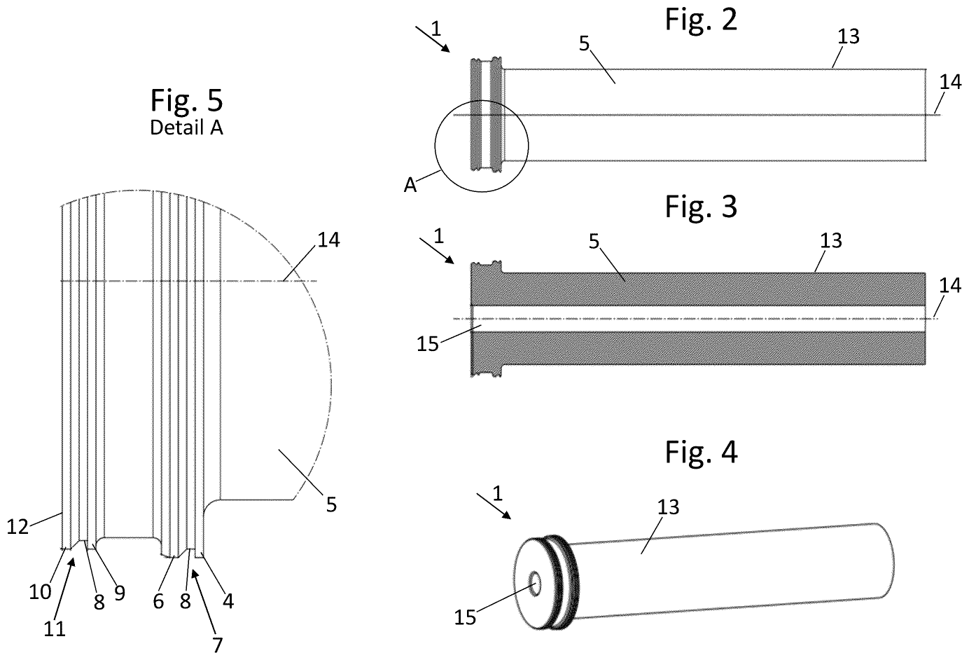

This sealant 16 can be provided by an applicator tool 1 as shown by FIGS. 2 to 6 in a first embodiment.

FIG. 2 shows a first embodiment of an applicator tool 1 according to certain aspects of the invention.

FIG. 3 shows a section through the base axis of the first embodiment of FIG. 2.

FIG. 4 shows a perspective view of the first embodiment of FIG. 2 or 3.

FIG. 5 shows the detail A indicated in FIG. 2.

As can be seen, the first embodiment of the applicator tool 1 shown by the FIGS. 2 to 5 comprises a base body 5.

A sealing portion 4 extends radially outwardly from a base body 5 of the applicator tool 1 for sealing abutment with the valve seat bore 2.

A wiper portion 6 extends radially outwardly from the base body 5 and narrower in diameter than the sealing portion 4.

A circumferential groove 7 is placed between the sealing portion 4 and the wiper portion 6 and is recessed relative to the wiper portion 6, wherein the circumferential groove 7 has a groove base 8 which is circumferentially continuous.

Furthermore, the circumferential groove 7 comprises a groove cross-section (can be seen by FIG. 5), wherein two groove flanks each pass on the first side into the groove base 8 and on the second side into the wiper portion 6 and/or the sealing portion 4.

The applicator tool 1 comprises furthermore
a further sealing portion 9 extending axially away from the wiper portion 6 having a reduced-diameter end portion opposite the wiper portion 6 for sealing cooperation with a reduced-diameter wall portion 19 of the valve seat bore 2,
a further wiper portion 10 extending radially outwardly from the base body 5 and narrower in diameter than the further sealing portion 9, and
a further circumferential groove 11 between the further sealing portion 9 and the further wiper portion 10, wherein the further circumferential groove 11 has a groove base 8 which is circumferentially continuous.

The further circumferential groove 11 is essentially designed the same way as the circumferential groove 7 (apart from the diameters).

Between the further sealing portion 9 and the wiper portion 6, the base body comprises a reduction 21.

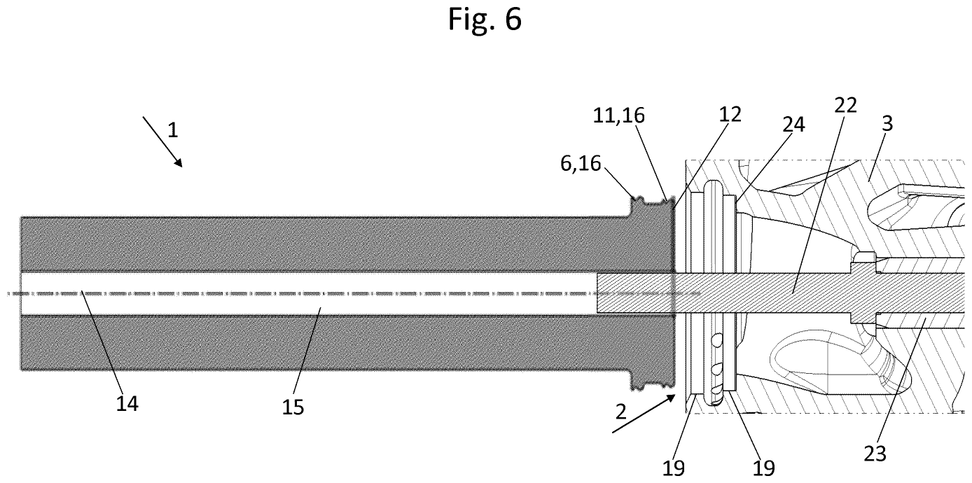

The applicator tool 1 is provided by a seat 12 in the form of an end face extending radially inwardly from the further wiper portion 10 for sealing cooperation with the valve seat bore 2 (in other words: the seat 12 is used as stop), which will later be described in more detail with reference to FIG. 6.

The first embodiment of the applicator tool 1 shown by FIGS. 2 to 5 comprises a handle portion 13 extending from the sealing portion 4 to a side facing away from the circumferential groove 7.

The whole applicator tool 1 is essentially rotationally symmetric regarding the base axis 14.

By the guiding opening 15, the applicator tool 1 can be guided during entering or extracting the applicator tool 1 at the valve seat bore 2.

The guiding opening 15 is entering the applicator tool 1 at the seat 12 permeating the whole applicator tool 1 along the base axis 14.

In the following, the usage of the applicator tool 1 shown by FIGS. 2 to 5 will be explained in more detail referring to FIG. 6.

In a first step, the operator is placing a sealant 16 into the circumferential groove 7 and into the further circumferential groove 11 of an applicator tool 1, wherein the sealant 16 is preferably liquid and is placed by a syringe body.

In a next step, the operator inserts the applicator tool 1 with the positioned sealant 16 into a valve seat bore 2 of the cylinder head 3 until the sealant 16 cooperates with the walls 19 of the valve seat bore 2. For this cooperation of the sealant 16 with the walls 19, the circumferential groove 7 and the further circumferential groove 11 are positioned accordingly, wherein the sealant 16 is applied to the walls 19 of the valve seat bore 2.

This positioning is done by use of the seat 12 which is inserted into the valve seat bore 2 until it is in contact with the leading edge 24—a cross section reduction—of the valve seat bore 2 (in other words: the seat 12 is used as a stop).

Before entering the valve seat bore 2, the projecting guiding pin 22 is introduced into the guiding opening 15 of the applicator tool 1 for guiding the applicator tool 1 during the entering, staying and exiting into, at or from the valve seat bore 2, wherein a gap size between the applicator tool 1 and the walls 19 of the valve seat bore 2 can be kept constant.

In a third step, the applicator tool 1 is removed from the valve seat bore 2, wherein, by the wiper portion 6 and the further wiper portion 10, an unnecessary amount of sealant 16 is removed.

In a next—fourth—step, the valve seat ring 17 is inserted into the valve seat bore 2, wherein a cavity 18 between the valve seat ring 17 and the valve seat bore 2 is sealed by the sealant 16.

Further, the liquid sealant 16 is hardening and connecting the valve seat ring 17 to the cylinder head 3 via the valve seat bore 2.

During the inserting of the valve seat ring 17 into the valve seat bore 2, the valve seat ring 17 is also guided and positioned by the guiding pin 22.

The guiding pin 22 is only used during installation of the valve seat ring 17 into the valve seat bore 2, wherein the guiding pin 22 is placed into the valve guiding sleeve 23.

After installing the valve seat ring 17, the guiding pin 22 is removed and the valve guiding sleeve 23 is used to guide the inlet or exhaust valves of the internal combustion engine during operation of the internal combustion engine.

### USED REFERENCE SIGNS

1 applicator tool
2 valve seat bore
3 cylinder head
4 sealing portion
5 base body
6 wiper portion
7 circumferential groove
8 groove base
9 further sealing portion
10 further wiper portion
11 further circumferential groove
12 seat
13 handle portion
14 base axis
15 guiding opening
16 sealant
17 valve seat ring
18 cooling cavity
19 wall
20 valve seat
21 reduction
22 guiding pin
23 valve guiding sleeve
24 leading edge

1. A system, comprising:
an applicator tool positionable within a valve seat bore of a cylinder head for an internal combustion engine, the applicator tool comprising:
a sealing portion extending radially outwardly from a base body of the applicator tool for sealing abutment with the valve seat bore,
a wiper portion extending radially outwardly from the base body and narrower in diameter than the sealing portion, and
a circumferential groove between the sealing portion and the wiper portion and recessed relative to the wiper portion, wherein the circumferential groove has a groove base which is circumferentially continuous.

2. The system according to claim 1, comprising:
a further sealing portion extending axially away from the wiper portion having a reduced-diameter end portion opposite the wiper portion for sealing cooperation with a reduced-diameter wall portion of the valve seat bore,
a further wiper portion extending radially outwardly from the base body and narrower in diameter than the further sealing portion, and
a further circumferential groove between the further sealing portion and the further wiper portion, wherein the further circumferential groove has a groove base which is circumferentially continuous.

3. The system according to claim 2, wherein a seat comprising an end face extends radially inwardly from the wiper portion or the further wiper portion for sealing cooperation with the valve seat bore or serves as stop.

4. The system according to claim 2, wherein a first sealant-receiving cavity extends circumferentially about the circumferential groove and is defined between the sealing portion, the wiping portion, and a wall of the valve seat bore when the applicator tool is positioned within the valve seat bore.

5. The system according to claim 4, wherein a second sealant-receiving cavity extends circumferentially about the further circumferential groove and is defined between the further sealing portion, the further wiping portion, and the wall of the valve seat bore when the applicator tool is positioned within the valve seat bore.

6. The system according to claim 1, wherein at least one handle portion extends from the sealing portion to a side facing away from the circumferential groove.

7. The system according to claim 1, wherein the applicator tool is rotationally symmetric about a base axis.

8. The system according to claim 1, wherein a guiding opening is provided entering the applicator tool at a seat, along a base axis.

9. The system according to claim 1, wherein the applicator tool is formed in one piece comprising a plastic material.

10. The system according to claim 1, comprising the cylinder head having the valve seat bore, a valve seat ring, or a combination thereof.

11. The system according to claim 10, comprising the internal combustion engine having the cylinder head with the valve seat ring sealed in the valve seat bore.

12. A method for applying a sealant to the valve seat bore of the cylinder head for the internal combustion engine using the applicator tool according to claim 1, comprising:
placing, in a first step, a sealant into the circumferential groove and/or into a further circumferential groove of the applicator tool,
inserting, in a second step, the applicator tool with the sealant into the valve seat bore of the cylinder head until the sealant cooperates with a wall of the valve seat bore, such that a seat of the applicator tool is contacting a corresponding cross section reduction of the valve seat bore, wherein the sealant is applied to the wall of the valve seat bore, and
removing, in a third step, the applicator tool from the valve seat bore, wherein, by the wiper portion and/or a further wiper portion, an unnecessary amount of sealant is removed.

13. A method for inserting a valve seat ring into the cylinder head of the internal combustion engine, comprising:
applying the sealant to the valve seat bore according to claim 12, and
inserting, in a fourth step, the valve seat ring into the valve seat bore, wherein a cavity between the valve seat ring and the valve seat bore is sealed by the sealant, and connecting the valve seat ring to the cylinder head via the valve seat bore by hardening of the sealant.

14. A method according to claim 13, wherein the applicator tool is guided by a guiding opening of the applicator tool and a corresponding guiding pin at least during the first and third step.

15. A system, comprising:
a valve seat ring configured to mount within a valve seat bore in a cylinder head of an internal combustion engine; and
an applicator tool configured to apply a sealant on the valve seat bore, wherein the applicator tool comprises:
a first annular sealing portion;
a first annular wiper portion; and
a first annular groove axially between the first annular sealing portion and the first annular wiper portion, wherein the first annular groove is configured to hold and apply the sealant on the valve seat bore.

16. The system of claim 15, comprising a guide pin configured to couple to the cylinder head, wherein the applicator tool comprises a guide opening configured to couple with the guide pin.

17. The system of claim 15, wherein the applicator tool comprises:
a second annular sealing portion;
a second annular wiper portion; and
a second annular groove axially between the second annular sealing portion and the second annular wiper portion, wherein the second annular groove is configured to hold and apply the sealant on the valve seat bore.

18. The system of claim 15, comprising a plurality of valve seat rings for the cylinder head, wherein the applicator tool is configured to apply the sealant on each of a plurality of valve seat bores of the cylinder head.

19. The system of claim 18, comprising the cylinder head.

20. The system of claim 19, comprising the internal combustion engine.
